(19) United States
(12) Patent Application Publication
(10) Pub. No.: US 2014/0180543 A1
(43) Pub. Date: Jun. 26, 2014

(54) VEHICLE CONTROL DEVICE

(71) Applicant: DENSO CORPORATION, Kariya-city (JP)

(72) Inventors: Yusuke Ueda, Nishio-shi (JP); Tomohiko Tsuruta, Aichi-ken (JP); Takeshi Hatoh, Nagoya (JP); Takayuki Kondoh, Kuwana-shi (JP); Naoya Inoue, Aichi-ken (JP)

(73) Assignee: DENSO CORPORATION, Kariya-city (JP)

(21) Appl. No.: 14/132,297

(22) Filed: Dec. 18, 2013

(30) Foreign Application Priority Data
Dec. 21, 2012 (JP) 2012-279592
Jun. 12, 2013 (JP) 2013-123846

(51) Int. Cl. B62D 6/00

(52) U.S. Cl. CPC B62D 6/00
USPC 701/41

(57) ABSTRACT

In a vehicle control device, a basic steering amount calculation section calculates a basic steering amount to drive an own vehicle on a basic route along a driving lave. A posture detection section detects a vehicle posture state indicated by a lateral position and an angle of yaw. An offset distance detection section detects an offset distance between the basis route and the lateral position. A correction steering amount calculation section calculates a correction steering amount as a steering control amount to drive the own vehicle along a virtual correction route. The posture of the own vehicle is alien with a predetermined target posture at a predetermined virtual target point by using the virtual correction route. An instruction steering amount calculation section calculates an instruction steering amount on the basis of the basic steering amount and the correction steering amount.

### CROSS-REFERENCE TO RELATED APPLICATION

This application is related to and claims priority from Japanese Patent Applications No. 2012-279592 filed on Dec. 21, 2012, and No. 2013-123846 filed on Jun. 12, 2013, the contents of which are hereby incorporated by reference.

### BACKGROUND OF THE INVENTION

1. Field of the Invention

The present invention relates to vehicle control devices for performing an automatic steering control.

2. Description of the Related Art

Recently, a vehicle control device using a lane keep assist (LKA) technique has been developed, which controls a vehicle to run on a driving lane without deviation from the driving lane. There is known a device as this kind of the vehicle control device. For example, a patent document, Japanese patent laid open publication No. JP2007-261449, discloses a device for determining a target point on a driving lane which is in front of a vehicle, for setting a target route so that the vehicle passes through the target point, and for adjusting a steering amount of the vehicle so that the vehicle passes the target point on the driving lane. Specifically, the vehicle control device disclosed in the above patent document presumes an arc route through which the vehicle runs to the target point, and determines the arc route as a driving route of the vehicle. A radius of curvature of the driving route is determined on the basis of a driving direction of the vehicle and the position of the target point.

However, the conventional vehicle control device disclosed in the patent document previously described has a problem of it being difficult to determine a driving route optimally adapted to the driving lane of the vehicle because the conventional vehicle control device determines the driving route of the vehicle without considering any shape of the driving lane.

### SUMMARY

It is therefore desired to provide a vehicle control device capable of determining a driving route optimally adapted to a shape of a driving lane of an own vehicle to which the vehicle control device is mounted.

An exemplary embodiment provides a vehicle control device comprised of a driving lane detection section, a basic steering amount calculation section, a posture detection section, an offset distance detection section, a correction steering amount calculation section and an instruction steering amount calculation section. The driving lane detection section detects a driving lane on which own vehicle is driving. The basic steering amount calculation section calculates a basic steering amount which is a steering control amount to drive the own vehicle on a basic route. The basic route is extended along a shape of the driving, lane of the own vehicle. The posture detection section detects a posture of the own vehicle designated by a lateral position and an angle of yaw of the own vehicle. The lateral position of the own vehicle is a position in a width direction of the driving lane. A route direction is a tangential direction of the basic route at the position of the own vehicle. The angle of yaw is a slope of the front direction of the own vehicle from the route direction.

The offset distance detection section detects, as an offset distance, a distance between the basic route and the lateral position of the own vehicle. The correction steering amount calculation section determines a virtual target point which is apart from a current position of the own vehicle by a predetermined distance in the route direction and is apart from the current position of the own vehicle by the offset distance in a width direction of the driving lane. The correction steering amount calculation section determines, as a correction route, a virtual driving route to alien the posture of the own vehicle to a target posture of the own vehicle which is determined in advance. The correction steering amount calculation section calculates, as the steering control amount, a correction steering amount in order to drive the own vehicle along the correction route.

The instruction steering amount calculation section calculates an instruction steering amount of the own vehicle on the basis of the basic steering amount and the correction steering amount. In the vehicle control device having the structure previously described, it is possible to calculate the instruction steering amount on the basis of the basic steering amount as the steering control amount to drive the own vehicle on the driving lane (as the basis route) along the shape of the driving lane and the correction steering amount as the steering control amount of the own vehicle to alien the posture of the own vehicle to the target posture. Accordingly, it is possible for the vehicle control device to obtain the driving lane which is fitted to the shape of the driving lane when compared with a conventional vehicle control device which determines an instruction steering amount without considering the shape of the driving lane.

### BRIEF DESCRIPTION OF THE DRAWINGS

A preferred, non-limiting embodiment of the present invention will be described by way of example with reference to the accompanying drawings, in which:

FIG. 1 is a view showing a block diagram of a vehicle control device according to a first exemplary embodiment of the present invention;

FIG. 2 a view showing an explanation of a detection area of an camera (image sensor) used by the vehicle control device according to the first exemplary embodiment shown in FIG. 1;

FIG. 3 is a view showing a flow chart for performing an automatic steering control process by the vehicle control device according to the first exemplary embodiment shown in FIG. 1;

FIG. 4 is a view showing an explanation of various parameters used in the automatic steering control process shown in FIG. 3;

FIG. 5 is a view showing a flow chart for calculating a basic steering amount of the vehicle by the vehicle control device according to the first exemplary embodiment shown in FIG. 1;

FIG. 6 is a view showing a flow chart for calculating a correction steering amount of the vehicle by the vehicle control device according to the first exemplary embodiment shown in FIG. 1;

FIG. 7A is a view showing an estimated driving route of own vehicle;

FIG. 7B is a view showing a basic route of the own vehicle;

FIG. 7C is a view showing a correction route of the own vehicle;

FIG. 8A is a view showing an estimated driving route when a preceding vehicle runs in front of the own vehicle on which the vehicle control device is mounted;

FIG. 8B is a view showing a basic route when a preceding vehicle runs in front of the own vehicle;

FIG. 8C is a view showing a correction route when a preceding vehicle runs in front of the own vehicle;

FIG. 9 is a view showing a flow chart for calculating a correction steering amount by the vehicle control device according to a second exemplary embodiment of the present invention;

FIG. 10A is a view showing an explanation of a first reference point and a second reference point used by the vehicle control device according to the second exemplary embodiment;

FIG. 10B is a view showing an explanation of one example of a correction route generated on the basis of the first reference point and the second reference point;

FIG. 11 is a view showing a flow chart for calculating a correction steering amount by the vehicle control device according to a third exemplary embodiment of the present invention;

FIG. 12A is a view showing an explanation of a virtual target point when the vehicle control device uses a correction distance X1;

FIG. 12B is a view showing an explanation of a virtual target point when the vehicle control device uses a correction distance X2;

FIG. 13 is a view showing a flow chart of an automatic steering control process performed by the vehicle control device according to a fourth exemplary embodiment of the present invention;

FIG. 14 is a view showing a flow chart of an automatic steering control process performed by the vehicle control device according to a fifth exemplary embodiment of the present invention;

FIG. 15A is a view showing an explanation of an correction route updating flag when an offset distance is Da;

FIG. 15B is a view showing an explanation of an correction route updating flag when an offset distance is Db;

FIG. 16 is a view showing a flow chart for calculating a correction steering amount by the vehicle control device according to a sixth exemplary embodiment of the present invention;

FIG. 17A is a view showing an explanation of a correction route updating period;

FIG. 17B is a view showing an explanation of a correction route;

FIG. 17C is a view showing an explanation of a correction updating period;

FIG. 17D is a view showing an explanation of a correction steering amount;

FIG. 18 is a view showing a flow chart for calculating a correction steering amount by the vehicle control device according to a seventh exemplary embodiment of the present invention;

FIG. 19A is a view showing an explanation of a case when the own vehicle deviates from the correction route;

FIG. 19B is an enlarged view of an area surrounded by a solid line designated in FIG. 19A;

FIG. 20 is a view showing a flow chart for performing an automatic steering control process by the vehicle control device according to an eighth exemplary embodiment of the present invention;

FIG. 21 is a view showing an explanation for calculating a new virtual target point;

FIG. 22 is a view showing an explanation of a route when the own vehicle runs on the basis of a correction steering amount which is set on the basis of the new correction route to the new virtual target point; and

FIG. 23 is a view showing an explanation for calculating a new virtual target point used in a second modification of the vehicle control device according to the eighth exemplary embodiment.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Exemplary Embodiment

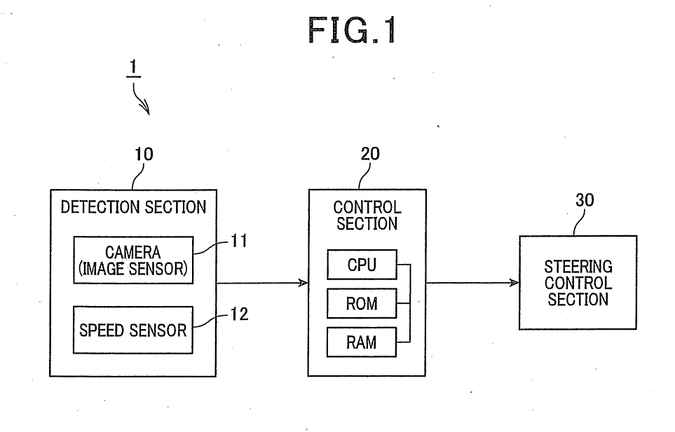

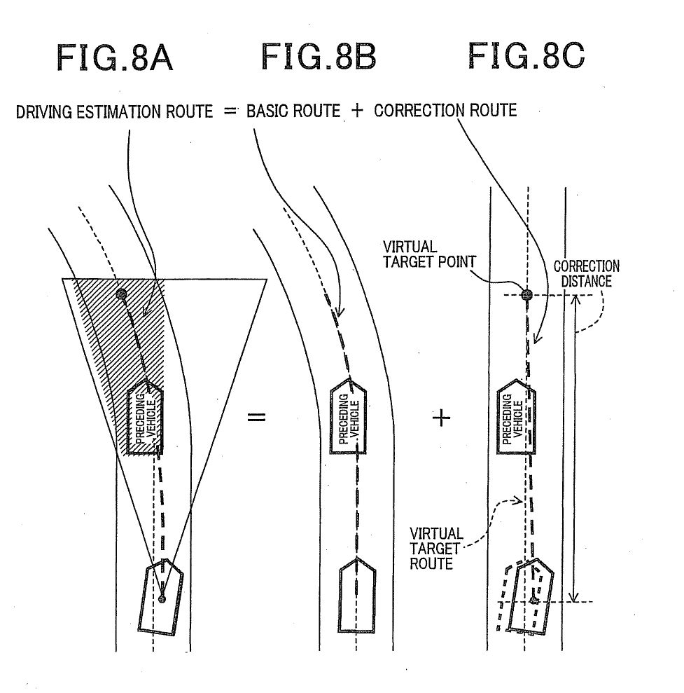

A description will be given of a vehicle control device according to a first exemplary embodiment with reference to FIG. 1 to FIG. 8A, FIG. 8B and FIG. 8C.

### [Overall Structure]

FIG. 1 is a view showing a block diagram of the vehicle control device according to the first exemplary embodiment. As shown in FIG. 1, the vehicle control device 1 is comprised of a detection section 10, a control section 20 and a steering control section 30. The detection section 10 detects a surrounding environment of own vehicle and vehicle conditions of the own vehicle. The control section 20 determines a driving route, on which the own vehicle is running, on the basis of the detection results of the detection section 10. The control section 20 generates a steering instruction. The own vehicle can drive on the determined detection route on the basis of the generated steering instruction. The steering control section 30 receives the steering instruction transmitted from the control section 20, and performs an automatic control of a steering device of the own vehicle on the basis of the received steering instruction.

The detection section 10 is comprised of a camera (as an image sensor) 11 and a speed sensor 12. The camera (image sensor) 11 detects a front environment in front of the own vehicle. The front environment is the surrounding environment of the own vehicle. The speed sensor 12 detects a vehicle speed of the own vehicle. The detected vehicle speed is used as one of the vehicle conditions.

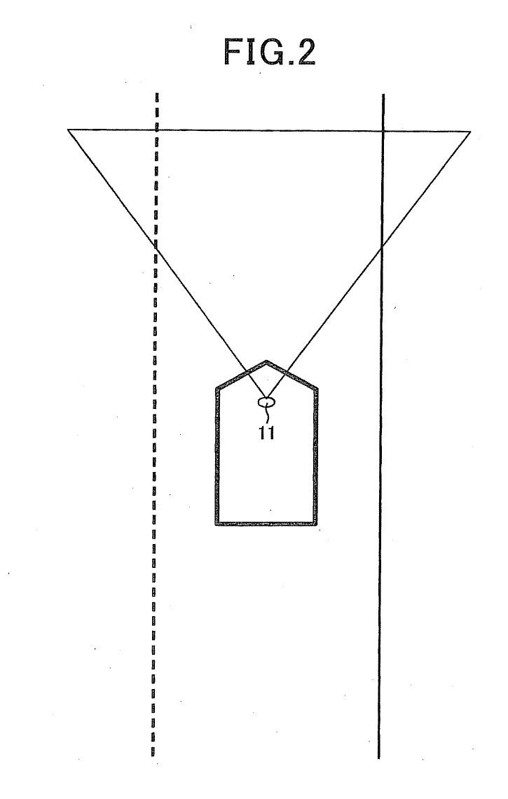

FIG. 2 is a view showing an explanation of a detection area of the camera (image sensor) 11 used by the vehicle control device 1 according to the first exemplary embodiment shown in FIG. 1. As shown in FIG. 2, the camera (image sensor) 11 is installed in front of a rear view mirror mounted in the inside of an interior of the own vehicle. The camera (image sensor) 11 detects a predetermined angle range around a forward direction of the own vehicle.

Because the steering section 30 performs the steering control of the steering device of the own vehicle on the basis of the steering instruction and this is widely known, the explanation thereof is omitted here for brevity.

The control section 20 is comprised of a microcomputer having a central processing unit (CPU), a read only memory (ROM) and a random access memory (RAM). Such a microcomputer is known and easily available in the commercial market. The control section 20 performs at least an automatic steering control in order to decrease a workload of a driver of the own vehicle.

A description will now be given of the detailed explanation of the automatic steering control process executed by the vehicle control device 1 according to the first exemplary embodiment.

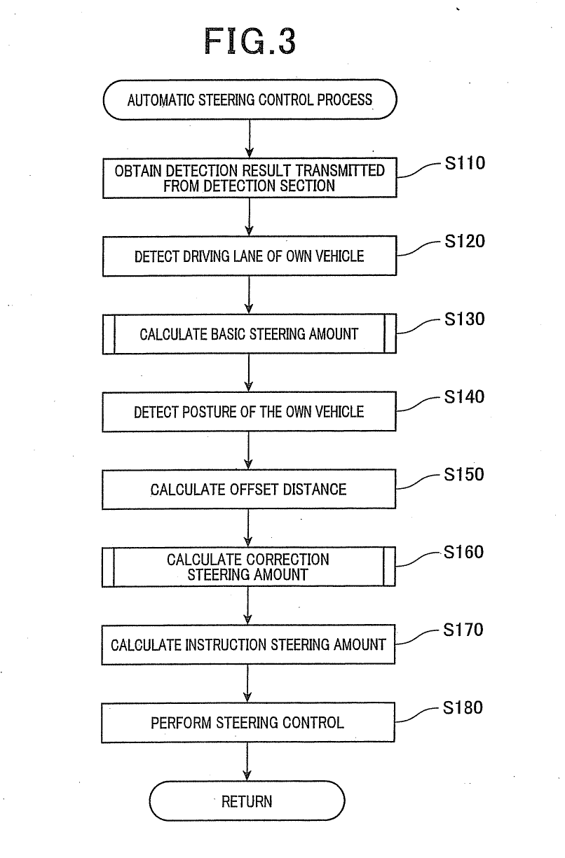

FIG. 3 is a view showing a flow chart for performing the automatic steering control process by the vehicle control device 1 according to the first exemplary embodiment shown in FIG. 1.

As shown in FIG. 3, the vehicle control device 1 performs the automatic steering control process shown in FIG. 3 every a predetermined period (start period T0) until a predetermined release condition is satisfied (for example, when the engine stops, and when the driver of the own vehicle operates a release switch) when a start switch (not shown) is turned on.

When the automatic steering control process shown in FIG. 3 is initiated, the control section 20 receives detection results as the surrounding environment and the vehicle conditions, for example, at least image data captured by the camera (image sensor) 11 and a vehicle speed detected by the speed sensor 12. The operation flow goes to step S120.

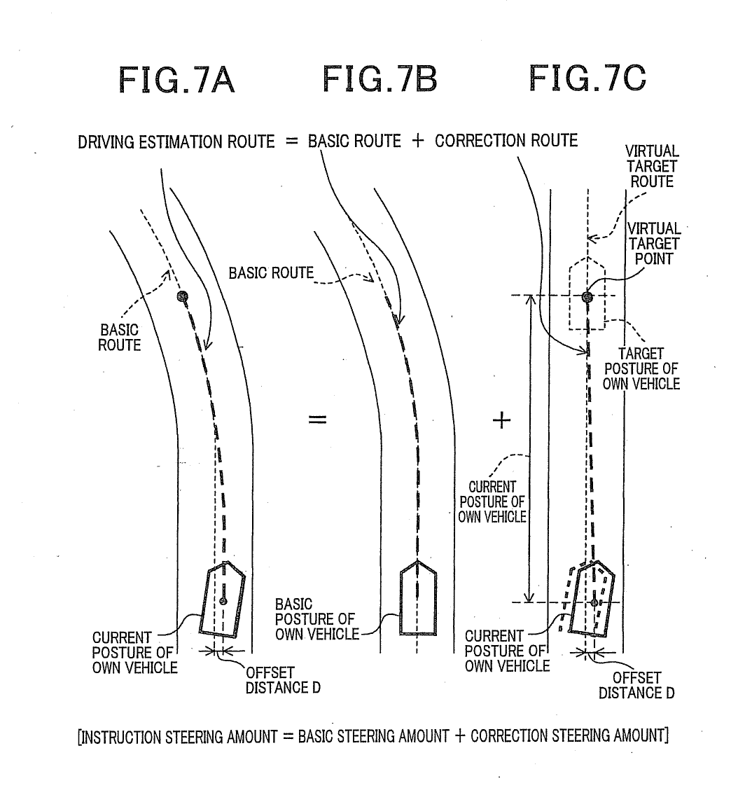

FIG. 7A is a view showing an estimated driving route. FIG. 7B is a view showing a basic route of the own vehicle. FIG. 7C is a view showing a correction route of the own vehicle. In step S120, the control section 20 detects a driving lane on which the own vehicle is currently driving. Specifically, the control section 20 detects a white line and a yellow line on the driving lane from the captured image data. Such a white line and a yellow line are boundary lines (a center line and roadway outside lines, etc.) which are painted on the driving lane. The control section 20 specifies the driving lane on which the own vehicle is currently running on the basis of the detected roadway boundary lines. The control section 20 uses the specified driving lane as the driving lane of the own vehicle. The operation flow goes to step S130.

In step S130, the control section 20 performs a basic steering amount calculation. The basic steering amount calculation calculates a basic steering amount which is a steering control amount necessary to drive the own vehicle on a basis route. The basic route is a target route of the own vehicle. That is, the basic steering amount calculation determines the basic route which passes through the center line of the driving lane and extended along the driving lane of the own vehicle (see FIG. 7B). The operation flow goes to step S140.

In step S140, the control section 20 detects a posture of the own vehicle from the captured image data designated by a lateral position and an angle of yaw of the own vehicle. The operation flow goes to step S150. In step S150, the control section 20 calculates an offset distance on the basis of the lateral position detected in step S140.

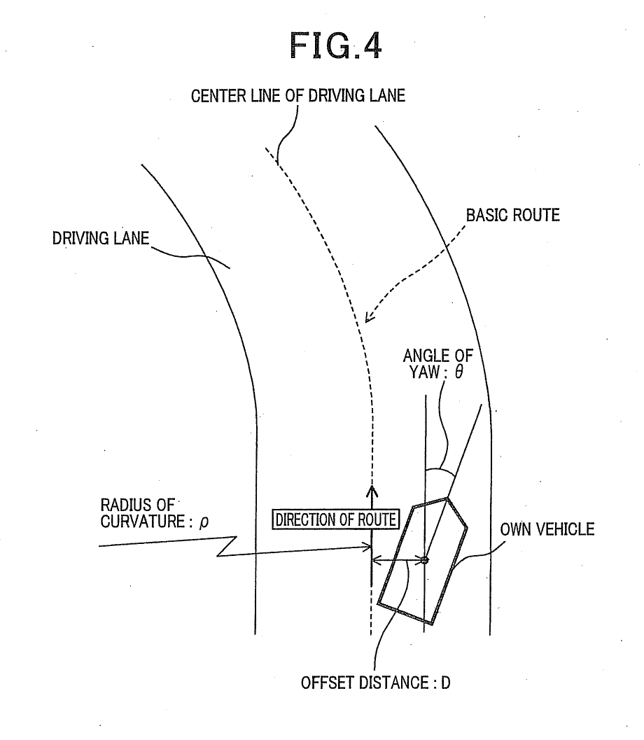

FIG. 4 is a view showing an explanation of various parameters used in the automatic steering control process shown in FIG. 3.

As shown in FIG. 4, the lateral position of the own vehicle is the position of the own vehicle in a width direction of the driving lane on which the own vehicle is running. Specifically, the lateral position of the own vehicle is designated by a distance measured from a predetermined reference position (for example, a left side of the driving lane). The offset distance D is a distance between the lateral position of the own vehicle and the basic route (that is, a distance between the lateral position and a center line of the driving lane). That is, the offset distance D is an amount of deviation of the own vehicle from the basic route (that is, the center line of the driving lane) in a width direction of the driving lane. In addition, the angle θ of yaw is a slope of the front direction of the own vehicle from the route direction along which the own vehicle is driving.

As shown in FIG. 4, when the own vehicle is not on the basic route, that is, the control section 20 determines, as the route direction, a tangential line of the basic route when the offset distance D is zero (D=0). In addition, the width direction is a direction which is perpendicular to the route direction. Hereinafter, the posture of the own vehicle is referred to as the “current posture of the own vehicle”.

When the offset distance D is zero (D=0) and the angle θ of yaw is zero (θ=0), the own vehicle has a basic posture. The operation flow goes to step S160.

In step S160, the control section 20 performs a correction steering amount calculation so as to obtain a correction steering amount as the steering control amount to move the own vehicle on the correction route (see FIG. 7B). The operation flow goes to step S170.

In step S170, the control section 20 calculates an instruction steering amount by adding the basic steering amount obtained in step S140 and the correction steering amount obtained in step S160. That is, the instruction steering amount is a sum of the basic steering amount obtained in step S140 and the correction steering amount obtained in step S160 (see FIG. 7A). The operation flow goes to step S180.

In step S180, the control section 20 outputs the instruction steering amount calculated in step S170 to the steering control section 30. The control section 20 completes the execution of the process routine designated by the flow chart shown in FIG. 3.

### [Calculation of Basic Steering Amount]

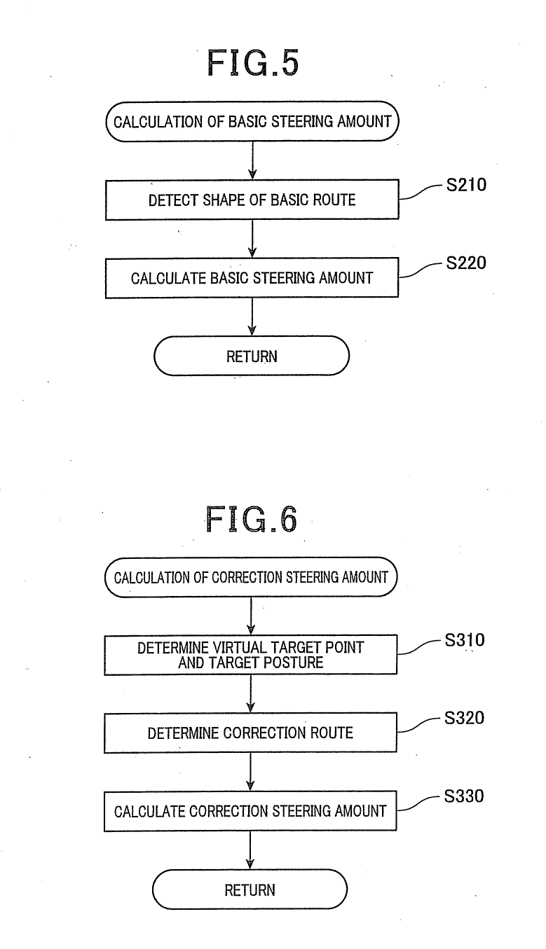

A description will now be given of the detailed calculation of the basic steering amount performed in step S130 with reference to FIG. 5.

FIG. 5 is a view showing a flow chart for calculating the basic steering amount of the own vehicle by the vehicle control device 1 according to the first exemplary embodiment shown in FIG. 1.

On performing the routine shown in FIG. 5, the control section 20 performs the process of step S210. In step S210, the control section 20 calculates an estimated value ρ of a radius of curvature of the basic route. The estimated value ρ is used as a shape of the basic route. The estimated value ρ is determined on the basis of a shape of lane boundary lines on the driving lane which is detected within a predetermined range (for example, within a range of several meters to several ten meters in front of the own vehicle). Specifically, the control section 20 calculates, as the estimated value ρ, an average value of a radius of curvature of a lane boundary line at a right side on the driving lane and a radius of curvature of a lane boundary line at a left side on the driving lane. The operation flow goes to step S220.

In step S220, the control section 20 calculates the basic steering amount to drive the own vehicle with the basic posture along the basic route. The control section 20 finishes the execution of the routine indicated by the flow chart shown in FIG. 5. In the routine shown in FIG. 5, the control section 20 calculates the basic steering amount which corresponds to both the vehicle speed obtained in step S110 and the estimated value ρ calculated in step S210 on the basis of a map. This map has a relationship between a vehicle speed, a radius of curvature of a driving lane and a steering amount on the basis of steering characteristics of the own vehicle which are detected in advance. The control section 20 calculates the basic steering amount so that the calculated basic steering amount exceeds a predetermined upper limit value. The upper limit value is determined in advance so that a passenger of the own vehicle does not have uncomfortable driving.

### [Calculation of Correction Steering Amount]

A description will now be given of the detailed calculation of the correction steering amount performed in step S160 with reference to FIG. 6. FIG. 6 is a view showing a flow chart for calculating a correction steering amount of the vehicle by the vehicle control device according to the first exemplary embodiment shown in FIG. 1.

When the control section 20 performs the routine indicated by the flow chart shown in FIG. 6, the control section 20 determines a virtual target point of the own vehicle and a target posture of the own vehicle in step S310. The virtual target point is a position which is apart from the current position of the own vehicle by a predetermined distance in a route direction of the own vehicle and is apart from the current position of the own vehicle by the offset distance D calculated in step S150 calculated in step S150 in a width direction of the driving lane (at the side of the basic route in both the right side and the left side in the width direction). Hereinafter, a virtual target route is apart from the current position of the own vehicle by the offset distance D in the width direction of the driving lane and is extended along the route direction. In the first exemplary embodiment, the virtual target route is a straight line route extended in the route direction passing through the center of the driving lane. The virtual target point is determined on the virtual target route. On the other hand, the target posture of the own vehicle is a target posture of the own vehicle at the virtual target point. In this case, the angle of yaw has zero. The operation flow goes to step S320.

In step S320, the control section 20 determines the correction route. The correction route is a driving route which is necessary to alien the current posture of the own vehicle to the target posture at the virtual target point. The control section 20 determines, as the correction route, a straight line route connected from the current position of the own vehicle to the virtual target point. The operation flow goes to step S330.

In step S330, the control section 20 calculates the correction steering amount as the steering amount to drive the own vehicle along the correction route. The control section 20 finishes the routine indicated by the flow chart shown in FIG. 6. The control section 20 calculates the correction steering amount so that the calculated correction steering amount exceeds a predetermined upper limit which is determined in advance. Like the basic steering amount, the upper limit value is determined in advance so that a passenger of the own vehicle does not have uncomfortable driving.

### [Operation]

As shown in FIG. 7A, FIG. 7B and FIG. 7C, the vehicle control device 1 according to the first exemplary embodiment having the structure previously described performs the steering control so that the own vehicle is running on the estimated driving route (see FIG. 7A) along the basic route on the basis of the instruction steering amount which is calculated on the basis of the basic steering amount and the correction steering amount. The basic steering amount is used to drive the own vehicle with the basic posture on the basic route (see FIG. 7B). The correction steering amount is used to drive the own vehicle on the correction route (see FIG. 7C) to shift the current posture to the target posture of the own vehicle.

### [Effects]

As previously described, the vehicle control device 1 according to the first exemplary embodiment calculates the instruction steering amount on the basis of the basic steering amount and the correction steering amount, where the basic steering amount is a steering control amount to drive the own vehicle on the driving route (basic route) along the shape of the driving lane, and the correction steering amount is a steering control amount to alien the posture of the own vehicle with the target posture. Accordingly, it is possible for the vehicle control device 1 according to the first exemplary embodiment to obtain the driving lane which is fitted to the shape of the driving lane when compared with a conventional vehicle control device which determines an instruction steering amount without considering the shape of the driving lane.

FIG. 8A is a view showing an estimated driving route when a preceding vehicle runs in front of the own vehicle on which the vehicle control device 1 is mounted. FIG. 8B is a view showing the basic route when a preceding vehicle runs in front of the own vehicle. FIG. 8C is a view showing the correction route when the preceding vehicle runs in front of the own vehicle.

In a case in which the camera 11 (as the image sensor) in the vehicle control device 1 cannot capture image in front of the own vehicle when the capturing range of the camera 11 is blocked by something, for example, in a case when there is a case shown in FIG. 8A where a preceding vehicle is running in front of the own vehicle, the control section 20 can calculate a basic steering amount on the basis of a shape of the driving road (the shape of the driving lane, see FIG. 8B) which is most recent image captured by the camera 11. The control section 20 in the vehicle control device 1 adjusts the basic steering amount by the correction steering amount which corresponds to the deviation to the target posture (see FIG. 8C). This makes it possible for the control section 20 to obtain the optimum instruction steering amount.

Accordingly, the vehicle control device 1 according to the first exemplary embodiment can perform a stable automatic steering control without regard to the recognition of forward image of the own vehicle, i.e., without regard to surrounding conditions of the own vehicle.

### [Correspondence to Claims]

The process in step S120 shown in FIG. 3 corresponds to the driving lane detection section used in the claims. The process in step S130 shown in FIG. 3 corresponds to the basic steering amount calculation section used in the claims. The process in step S140 shown in FIG. 3 corresponds to the posture detection section used in the claims. The process in step S150 shown in FIG. 3 corresponds to the offset distance detection section used in the claims. The process in step S160 shown in FIG. 3 corresponds to the correction steering amount calculation section used in the claims. The process in step S170 shown in FIG. 3 corresponds to the instruction steering amount calculation section used in the claims. The process in step S180 shown in FIG. 3 corresponds to the automatic steering section used in the claims.

### Second Exemplary Embodiment

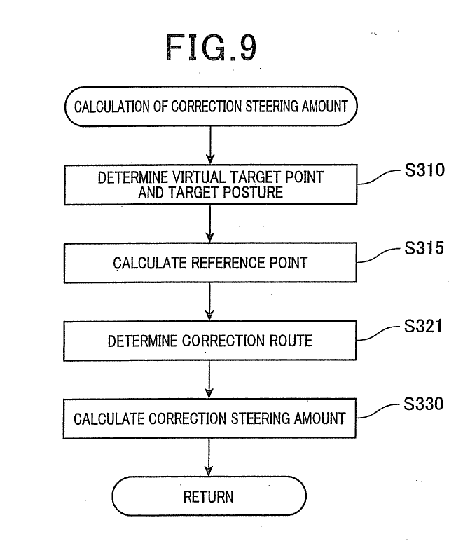

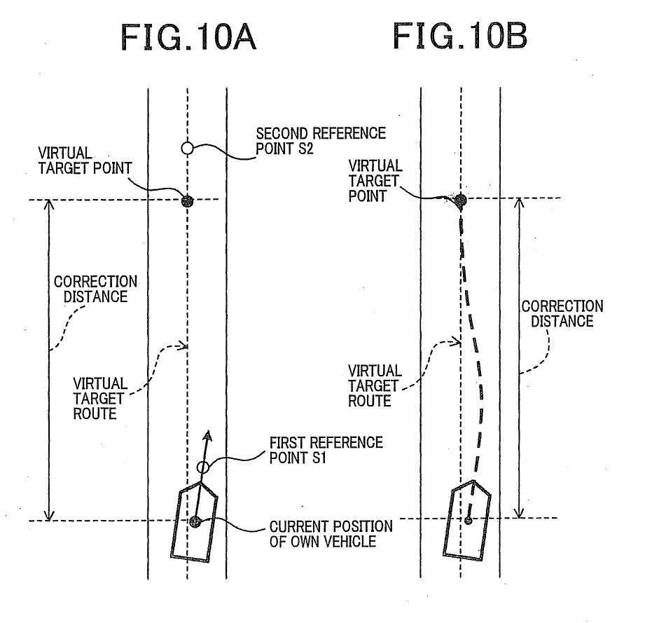

A description will be given of the vehicle control device according to a second exemplary embodiment with reference to FIG. 9, FIG. 10A and FIG. 10B.

### [Structure]

The vehicle control device according to the second exemplary embodiment has the same structure of the vehicle control device 1 according to the first exemplary embodiment. In particular, the vehicle control device according to the second exemplary embodiment is different in a part of the correction steering amount calculation process performed by the control section 20 from the vehicle control device 1 according to the first exemplary embodiment. The difference between the second exemplary embodiment and the first exemplary embodiment will be explained, and the explanation of the same components is omitted here.

### [Correction Steering Amount Calculation Process]

FIG. 9 is a view showing a flow chart for calculating a correction steering amount by the vehicle control device according to a second exemplary embodiment.

When compared with the correction steering amount calculation process shown in FIG. 6, the step S320 is replaced with a new step S321 and a new step S315 is added in the correction steering amount calculation process shown in FIG. 9 performed by the vehicle control device according to the second exemplary embodiment.

That is, in step S315 after the process in step S310, the control section 20 determines at least two reference points.

FIG. 10A is a view showing an explanation of a first reference point and a second reference point used by the vehicle control device according to the second exemplary embodiment. FIG. 10B is a view showing an explanation of one example of a correction route generated on the basis of the first reference point and the second reference point.

Specifically, as shown in FIG. 10A, the control section 20 determines a first reference point S1 and a second reference point S2 so that the first reference point S1 is on a forward direction of the own vehicle, and the second reference point S2 is on a virtual target route. The second reference point S2 is a distant point when compared with the virtual point determined in step S310. The operation flow goes to step S315.

In step S315, the control section 20 determines a correction route on the basis of the first reference point S1 and the second reference point S2 by performing a curve fitting as a spline interpolating. The operation flow goes to step S330.

In step S330, the control section 20 calculates a correction steering amount on the basis of the correction route obtained in step S321. The control section 20 completes the routine indicated by the flow chart shown in FIG. 9.

### [Effects]

According to the vehicle control device of the second exemplary embodiment, as previously described and shown in FIG. 10B, it is possible to suppress a rapid steering or a forced steering which provides uncomfortable driving to the passenger of the own vehicle.

### Third Exemplary Embodiment

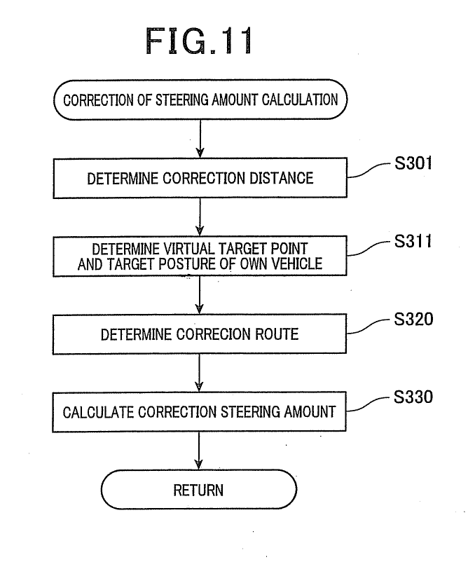

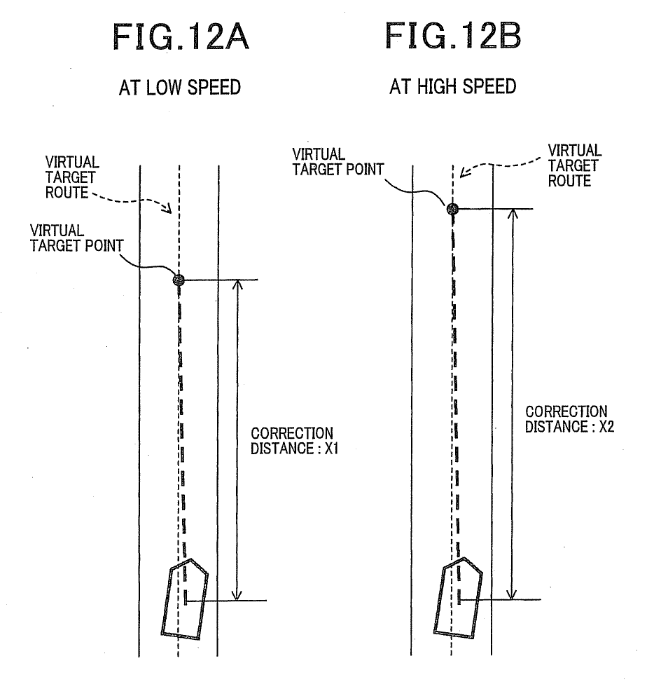

A description will be given of the vehicle control device according to a third exemplary embodiment with reference to FIG. 11 and FIG. 12A and FIG. 12B.

The vehicle control device according to the third exemplary embodiment has the same structure of the vehicle control device according to the first exemplary embodiment. In particular, the vehicle control device according to the third exemplary embodiment is different in the correction steering amount calculation process performed by the control section 20 from the vehicle control device according to the first exemplary embodiment. The explanation of the same components and operations between the third exemplary embodiment and the first exemplary embodiment is omitted here.

### [Correction Steering Amount Calculation Process]

FIG. 11 is a view showing a flow chart for calculating a correction steering amount by the vehicle control device according to the third exemplary embodiment.

When compared with the correction steering amount calculation process shown in FIG. 6, the step S310 is replaced with a new step S311 and a new step S301 is added in the correction steering amount calculation process shown in FIG. 11 performed by the vehicle control device according to the third exemplary embodiment.

That is, when the routine indicated by the flow chart shown in FIG. 11 is started, the control section 20 determines a correction distance D on the basis of at least one state amount selected from a vehicle speed, a lateral acceleration applied to the own vehicle, a steering angle, a lateral position of the target posture and an offset distance of the target posture. In the third exemplary embodiment, the control section 20 determines a correction distance on the basis of the vehicle speed detected in step S110 shown in FIG. 3. In the third exemplary embodiment, the more the vehicle speed is high, the more the correction distance is increased. The operation flow goes to step S311.

In step S311, although the process in step S311 is similar to the process in step S310, the control section 20 determines a virtual target position on the basis of the correction distance D obtained in step S301. After the processes in step S320 and step S330, the control section 20 completes the routine indicated by the flow chart shown in FIG. 11.

### [Effects]

FIG. 12A is a view showing an explanation of a virtual target point when the vehicle control device uses a correction distance X1. FIG. 12B is a view showing an explanation of a virtual target point when the vehicle control device uses a correction distance X2.

As previously described, according to the third exemplary embodiment, when the vehicle speed of the own vehicle is low, the control section 20 determines a virtual target point which corresponds to the correction distance X1, as shown in FIG. 12A. On the other hand, when the vehicle speed of the own vehicle is high, the control section 20 determines a virtual target point which corresponds to the correction distance X2 shown in FIG. 12B and is far from the virtual target point determined when the vehicle speed is low. That is, the more the vehicle speed is high, the more the virtual target point is far from the current position of the own vehicle. This makes it possible to suppress a rapid steering or a forced steering and to provide a stable steering control.

### [Modifications]

The control section 20 determines the correction distance D on the basis of the vehicle speed of the own vehicle. However, the concept of the present invention is not limited by this structure. For example, it is possible for the control section 20 to determine the correction distance D on the basis of a posture of the own vehicle detected in step S140 shown in FIG. 3 so that the more the offset distance of the target posture is increased, the more the correction distance is increased. It is also possible for the control section 20 to determine the correction distance D so that the more the angle of yaw of the target posture is increased, the more the correction distance is increased.

It is possible that the detection section 10 in the vehicle control device further has a lateral acceleration detection sensor capable of detecting a lateral acceleration applied to the own vehicle, and performs the correction steering amount calculation process to determine the correction distance so that the more the detected lateral acceleration is large, the more the correction distance is increased.

Furthermore, it is possible for the detection section 10 in the vehicle control device to has a steering angle sensor capable of detecting a steering angle, and for the control section 20 to perform the correction steering amount calculation process to determine the correction distance so that the more the detected steering angle is large, the more the correction distance is increased. The modifications previously described have the same effects of the first, second and third exemplary embodiments.

### Fourth Exemplary Embodiment

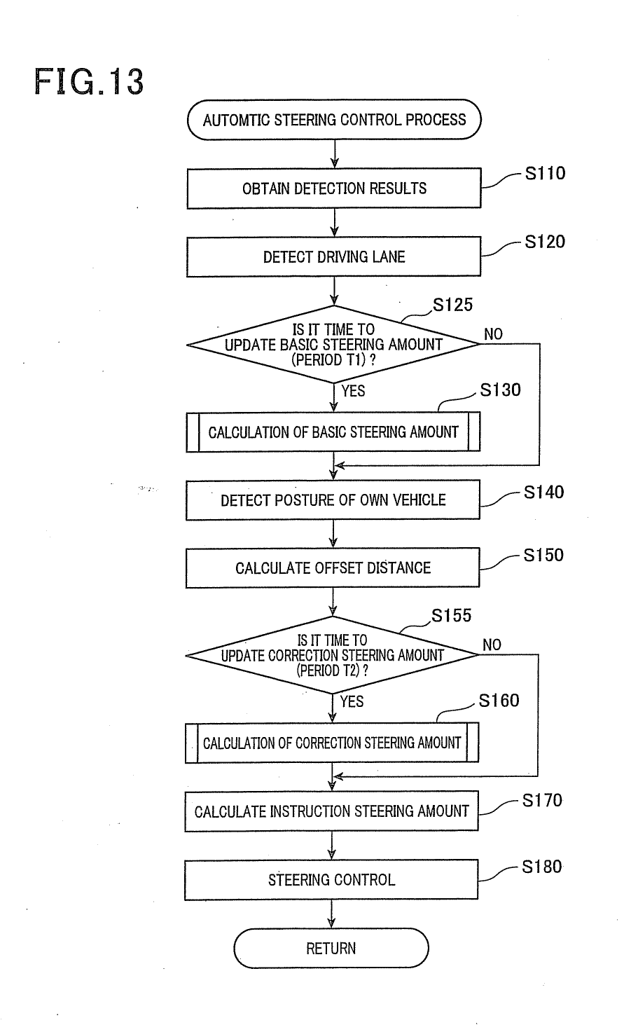

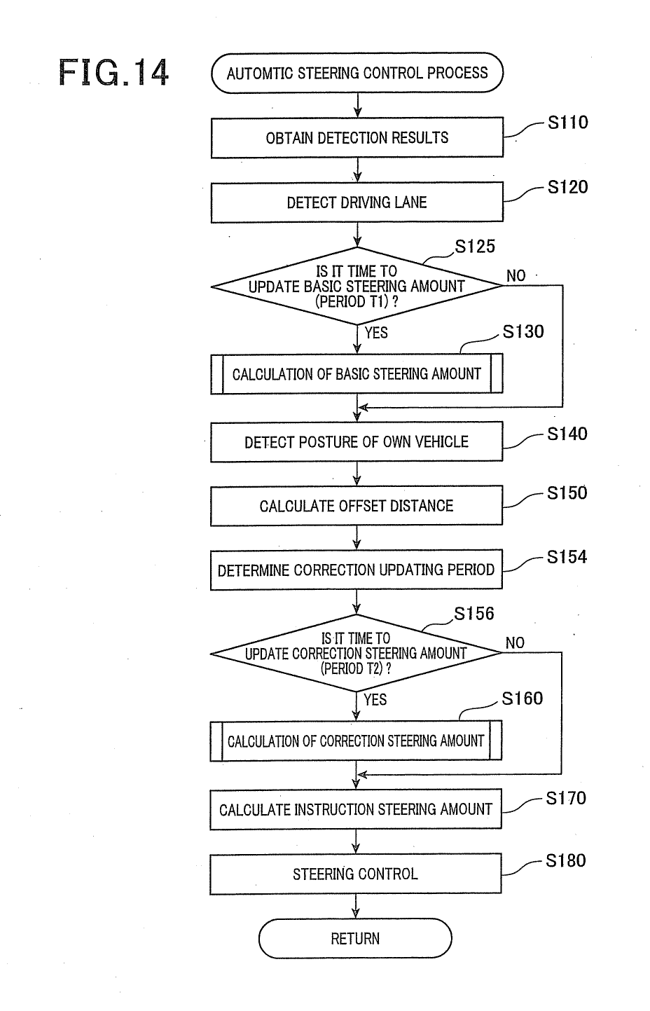

A description will be given of the vehicle control device according to a fourth exemplary embodiment with reference to FIG. 13.

### [Structure]

The vehicle control device according to the fourth exemplary embodiment has the same structure of the vehicle control device 1 according to the first exemplary embodiment. In particular, the vehicle control device according to the fourth exemplary embodiment is different in the automatic steering control process performed by the control section 20 from the vehicle control device 1 according to the first exemplary embodiment. The difference between the fourth exemplary embodiment and the first exemplary embodiment will be explained, and the explanation of the same components is omitted here.

### [Automatic Steering Control Process]

FIG. 13 is a view showing a flow chart of the automatic steering control process performed by the vehicle control device according to the fourth exemplary embodiment.

When compared with the automatic steering control process shown in FIG. 3, step S125 and step S155 are added to the automatic steering control process shown in FIG. 13.

That is, after the process in step S110 and the process in step S120, the control section 20 judges whether or not it is a time to update the basic steering amount in step S125. When the judgment result of step S125 indicates negation (“N” in step S125), the operation flow goes to step S140.

On the other hand, when the judgment result of step S125 indicates affirmation (“Y” in step S125), the operation flow goes to step S130. In step S130, the control section 20 calculates the basis steering amount, and the operation flow goes to step S140.

After the processes in step S140 and step S150, the operation flow goes to step S155. In step S155, the control section 20 judges whether or not it is a time to update the correction steering amount.

When the judgment result of step S155 indicates negation (“N” in step S155), the operation flow goes to step S170.

On the other hand, when the judgment result of step S155 indicates affirmation (“Y” in step S155), the operation flow goes to step S160. In step S160, the control section 20 calculates the correction steering amount, and the operation flow goes to step S170.

After the processes in step s170 and S180, the control section 20 completes the routine indicated by the flow chart shown in FIG. 13.

Specifically, the control section 20 judges whether or not it is a time to update the correction steering amount when detecting a basic updating flag which is set every passing the basic updating period T1 and a correction updating flag which is set every passing through the correction updating period T2, where the basic updating period T1 is set in advance to update the basic steering amount, and the correction updating period T2 which is set in advance to update the correction steering amount. In this case, the correction updating period T2 is set within a range of not less than a starting period T0 (T0≦T2) and less than the basic updating period T1.

### [Effects]

As previously described, because the control section 20 in the vehicle control device according to the fourth exemplary embodiment updates the correction route with a period which is shorter in time than the period of the basic route, it is possible to perform the steering control along the basic route with high accuracy.

### Fifth Exemplary Embodiment

A description will be given of the vehicle control device according to a fifth exemplary embodiment with reference to FIG. 13.

### [Structure]

The vehicle control device according to the fifth exemplary embodiment has the same structure of the vehicle control device 1 according to the first exemplary embodiment. In particular, the vehicle control device according to the fifth exemplary embodiment is different in the automatic steering control process performed by the control section 20 from the vehicle control device 1 according to the first exemplary embodiment. The difference between the fifth exemplary embodiment and the first exemplary embodiment will be explained, and the explanation of the same components is omitted here.

### [Automatic Steering Control Process]

FIG. 14 is a view showing a flow chart of the automatic steering control process performed by the vehicle control device according to the fifth exemplary embodiment.

When compared with the automatic steering control process shown in FIG. 13, the step S155 is replaced with a new step S156, and a new step S154 is added in the automatic steering control process shown in FIG. 14 performed by the vehicle control device according to the fifth exemplary embodiment.

That is, in step S154, the control section 20 determines the correction updating period T2 on the basis of the vehicle conditions detected in step S110. The operation flow goes to step S156.

In step S156, the control section 20 judges whether or not it is a time to update the correction steering amount on the basis of the correction updating period T2 obtained in step S154. Specifically, the more the offset distance D detected in step S150 shown in FIG. 3 is decreased, the more the correction updating period T2 is shorter.

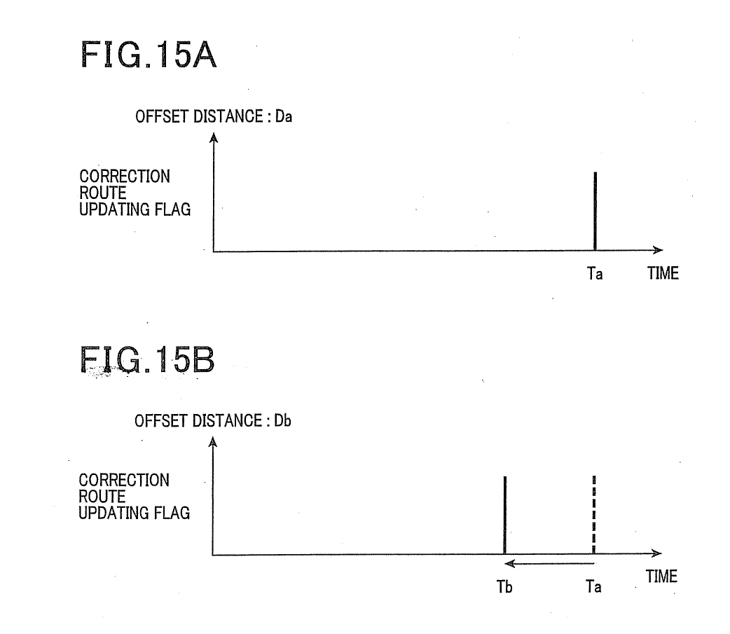

FIG. 15A is a view showing an explanation of an correction route updating flag when an offset distance is Da. FIG. 15B is a view showing an explanation of an correction route updating flag when an offset distance is Db.

For example, when detecting the offset distance Da and the offset distance Db in step S150, the control section 20 determines the correction updating period Tb so that the correction updating period Tb at the offset distance Db, as shown in FIG. 15B, is shorter in time than the correction updating period Ta (see FIG. 15A) at the offset distance Da.

### [Effects]

As previously described, the control section 20 in the vehicle control device according to the fifth exemplary embodiment increases the updating frequency according to the decrease of the offset distance. That is, the control section 20 in the vehicle control device according to the fifth exemplary embodiment increases the frequency to update the instruction steering amount according to when the more the own vehicle approaches the target basic route. It is therefore possible to perform the steering control along the basic route with high accuracy.

### [Correspondence to the Claims]

The process in step S154 shown in FIG. 14 corresponds to the correction updating period setting section used in the claims.

### Sixth Exemplary Embodiment

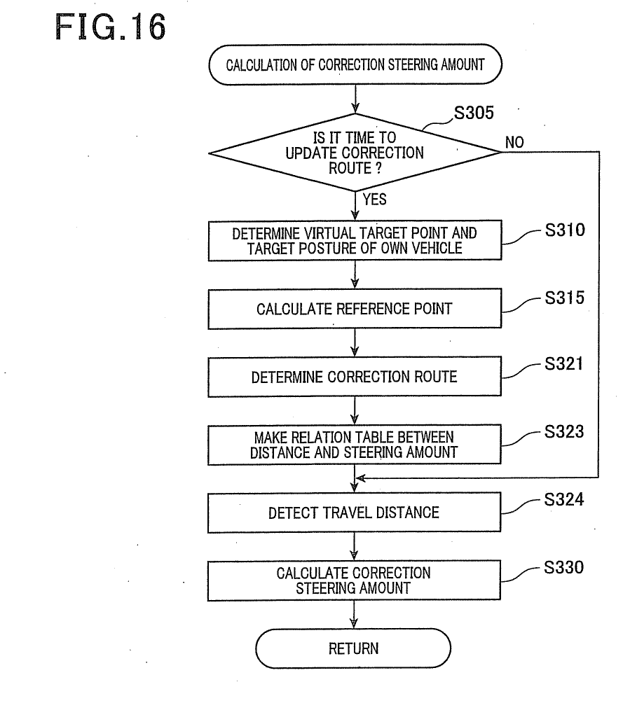

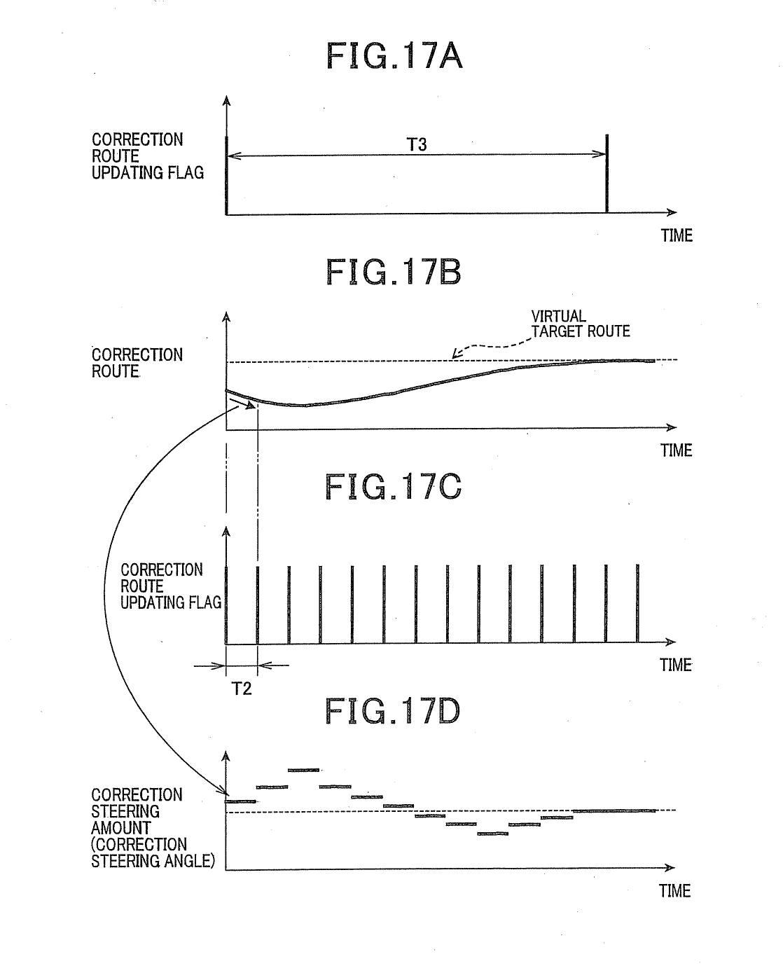

A description will be given of the vehicle control device according to a sixth exemplary embodiment with reference to FIG. 16 and FIG. 17A to FIG. 17D.

### [Structure]

The vehicle control device according to the sixth exemplary embodiment has the detection section 10 equipped with a movement distance detection sensor in addition to the components of the vehicle control device shown in FIG. 1. The movement distance detection sensor detects the travel distance of the own vehicle. It is possible to detect the travel distance of the own vehicle by using pulse signals transmitted form a sensor which counts the rotation umber of the vehicle wheels of the own vehicle.

The control section 20 performs the automatic steering control process which is the same process of the fourth exemplary embodiment shown in FIG. 13. In the fifth exemplary embodiment, the correction updating period T2 is equal to the start period T0 (T0=T2). In addition, because a part of the correction steering amount calculation performed by the control section of the sixth exemplary embodiment is different from the process of the second exemplary embodiment, the difference will be explained here.

### [Correction Steering Amount Calculation]

FIG. 16 is a view showing a flow chart for calculating the correction steering amount by the vehicle control device according to the sixth exemplary embodiment.

As shown in FIG. 16, the correction steering amount calculation process of the sixth exemplary embodiment has the processes in step S305, S323 and S324 in addition to the processes shown in FIG. 9.

When performing the correction control calculation process, the control section 20 judges whether or not it is a time to update the correction route in step S305. Specifically, when detecting the correction route updating flag, the control section 20 judges that it is the time to update the correction route. The correction route updating flag is generated every time when a correction route updating timer detects the elapse of the correction route updating period T3. The correction route updating timer is reset when the correction route updating flag is outputted. The correction route updating period T3 is larger than the correction route updating period T3 (T3>T2), and equal in period to the starting period T0 (T2=T0).

When the judgment result indicates negation (“N” in step 305), the operation flow goes to step S324. On the other hand, when the judgment result indicates affirmation (“Y” in step 305), the operation flow goes to step S310. In the latter case, the control section 20 performs the steps S310 to S321 to determine the correction route of the own vehicle. The operation flow goes to step S323.

In step S323, the control section 20 generates a table which showing a relationship between a travel distance on the correction route and a steering amount necessary to continue the travel of the correction route. After making the table, the operation flow goes to step S324.

Next, in step S324, the control section 20 detects the travel distance on the basis of the pulse signals detected in step S110. The operation flow goes to step S330. In step S330, the control section 20 calculates the correction steering amount which corresponds to the travel distance detected in step S324 on the basis of the table generated in step S322. After this, the control section 20 completes the routine indicated by the flow chart shown in FIG. 16.

### [Effects]

As previously described, the vehicle control device according to the sixth exemplary embodiment can optionally determine the period to update the basic steering amount, the correction route, the correction steering amount.

FIG. 17A is a view showing an explanation of the correction route updating period. FIG. 17B is a view showing an explanation of the correction route. FIG. 17C is a view showing an explanation of the correction updating period. FIG. 17D is a view showing an explanation of the correction steering amount.

Regarding the correction route (see FIG. 17B) which is updated every the correction route updating period T3 (see FIG. 17A), which is shorter than the basic updating period T1, it is possible for the control section 20 of the vehicle control device according to the sixth exemplary embodiment to update the correction steering angle (see FIG. 17D) every the correction updating period T2 (see FIG. 17C), which is shorter than the correction route updating period T3.

In this case, the control section 20 calculates the correction steering angle as the correction steering amount.

However, the concept of the present invention is not limited by this. It is possible to use various control values as the correction steering amount.

Because this makes it possible to update the correction steering amount ay a short period, the control section 20 of the vehicle control device according to the sixth exemplary embodiment can perform the steering control of the own vehicle along the target basic route. In particular, it is possible for the control section 20 to provide the excellent effects when the correction route has a curved shape.

### Seventh Exemplary Embodiment

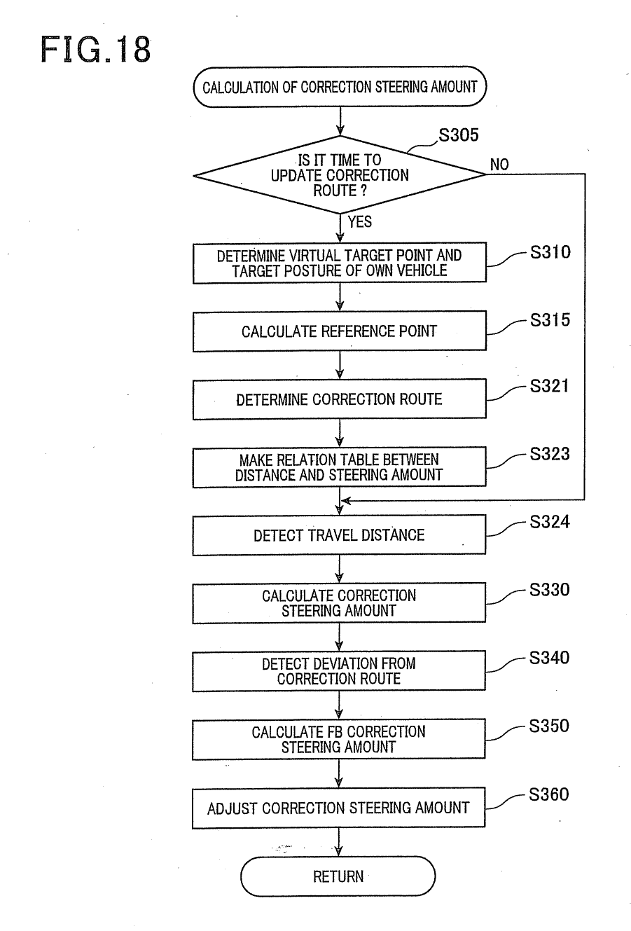

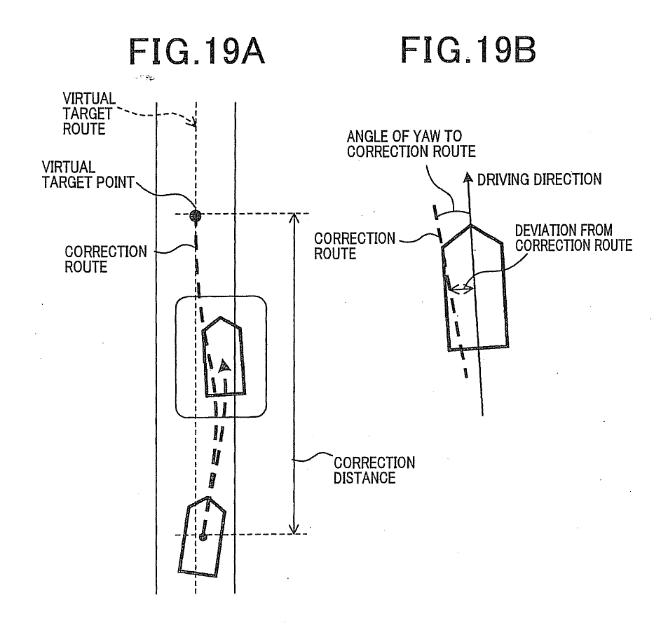

A description will be given of the vehicle control device according to a seventh exemplary embodiment with reference to FIG. 18, FIG. 19A and FIG. 19B.

### [Structure]

The vehicle control device according to the seventh exemplary embodiment has the same structure of the vehicle control device according to the fourth exemplary embodiment. The control section 20 in the vehicle control device according to the seventh exemplary embodiment performs the automatic steering control process which is the same process of the vehicle control device according to the fourth exemplary embodiment. However, a part of the correction steering amount calculation process performed in the seventh embodiment is different from that of the fourth exemplary embodiment. The difference between the seventh exemplary embodiment and the fourth exemplary embodiment will be explained.

### [Correction Steering Amount Calculation]

FIG. 18 is a view showing a flow chart for calculating the correction steering amount by the control section 20 of the vehicle control device according to the seventh exemplary embodiment.

As shown in FIG. 18, the correction steering amount calculation performed by the control section 20 of the seventh exemplary embodiment has steps S340 to S360 in addition to the steps shown in FIG. 16.

That is, after the steps S310 to S330, the operation flow goes to step S340. In step S340, the control section 20 compares the posture of the own vehicle detected in step S140 shown in FIG. 13 with the correction route determined in step S321, and detects a deviation in posture of the own vehicle to the correction route. The operation flow goes to step S350.

In step S350, the control section 20 calculates a feedback correction steering amount (FB correction steering amount) on the basis of the deviation detected in step S340. The operation flow goes to step S360. In step S360, the control section 20 adjusts the correction steering amount calculated in step S330 on the basis of the FB correction steering amount calculated in step S350, and outputs the adjusted value as the correction steering amount to the steering control section 30. The control section 20 completes the execution of the routine designated by the flow chart shown in FIG. 18.

### [Effects]

As previously described, it is possible for the control section 20 in the vehicle control device according to the seventh exemplary embodiment determines the correction steering amount by adjusting the deviation of the posture of the own vehicle to the correction route.

FIG. 19A is a view showing an explanation of a case when the own vehicle deviates from the correction route. FIG. 19B is an enlarged view of an area surrounded by a solid line designated in FIG. 19A. This makes it possible to adjust the correction steering amount by using the FB correction steering amount on the basis of the deviation of the posture of the own vehicle (a deviation of the posture of the own vehicle to the angle of yaw to the correction route and a deviation of the posture of the own vehicle to the correction route) as shown in FIG. 19B even if the posture of the own vehicle is deviated to the correction route shown in FIG. 19B by cross wind, wheel tracks, and a cross grade of a road.

Accordingly, it is possible for the control section 20 to trace the correction route with high accuracy, and as a result, it is possible for the control section 20 to perform the steering control along the target basic route with high accuracy.

### [Correspondence to Claims]

The processes in step S340 to S360 shown in FIG. 18 correspond to the correction steering amount adjustment section used in the claims.

### Eighth Exemplary Embodiment

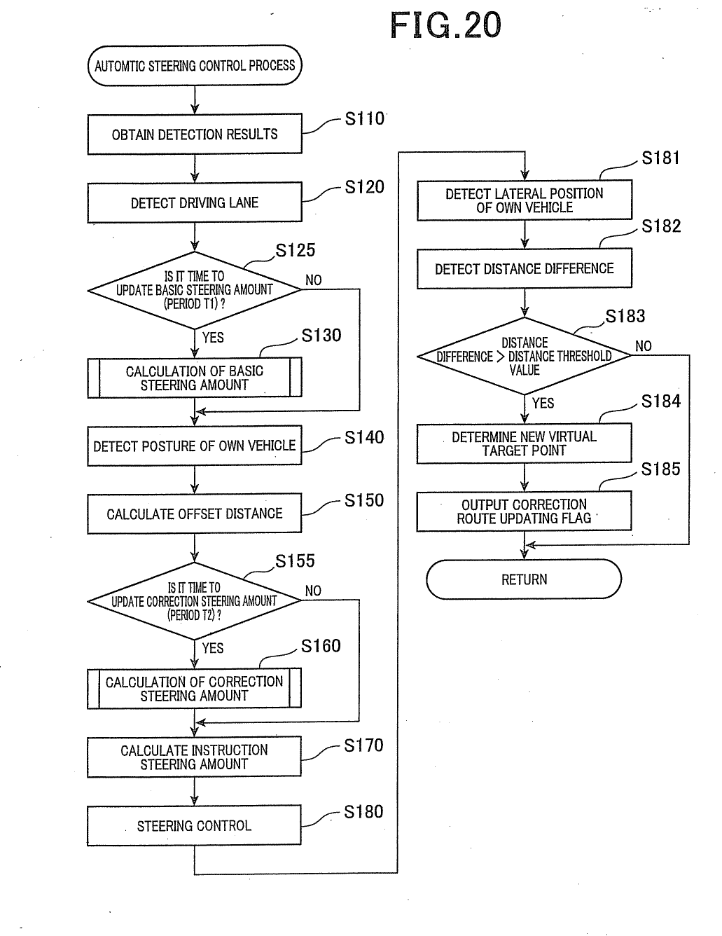

A description will be given of the vehicle control device according to an eighth exemplary embodiment with reference to FIG. 20 to FIG. 23.

### [Structure]

The vehicle control device according to the eighth exemplary embodiment has the same structure of the vehicle control device according to the sixth exemplary embodiment. A difference between the eighth exemplary embodiment and the sixth exemplary embodiment will be explained, and the explanation of the same components is omitted here.

### [Automatic Steering Control Process]

The control section 20 in the vehicle control device according to the eighth exemplary embodiment performs the correction steering amount calculation process which is the same of the correction steering amount calculation process (see FIG. 16) performed by the control section in the vehicle control device according to the sixth exemplary embodiment. The control section 20 in the vehicle control device according to the eighth exemplary embodiment performs the automatic steering control process which is different from the automatic steering control process (see FIG. 13) performed by the control section according to the sixth exemplary embodiment.

FIG. 20 is a view showing a flow chart for performing an automatic steering control process by the vehicle control device according to an eighth exemplary embodiment.

As shown in FIG. 20, the automatic steering control process performed by the control section 20 according to the eighth exemplary embodiment has the processes in steps S181 to S185 in addition to the processes in the automatic steering control process performed by the control section 20 according to the sixth exemplary embodiment.

That is, after the process in steps S110 to S180, the control section 20 performs the process in step S181. In step S181, the control section 20 detects a lateral position of the own vehicle in a width direction of the driving lane.

The correction steering amount is a steering amount to drive the own vehicle along the correction route. However, there is a possibility that the own vehicle runs on a route which strays from the correction route by some reasons such as lateral slope of the driving road, a detection error of the angle of yaw, a detection error of the offset distance.

The operation flow goes to step S182. In step S182, the control section 20 detects a distance difference (which is a difference in a width direction of the road) between a lateral position when the own vehicle is running along the correction route and an actual lateral position of the own vehicle. The operation flow goes to step S183. In step S183, the control section 20 judges whether or not the distance difference obtained in step S182 exceeds a distance threshold value. When the judgment result in step S182 indicates negation, i.e. that the distance difference is not more than the distance threshold value (“N” in step S182), the control section 20 completes the routine indicated by the flow chart shown in FIG. 20. On the other hand, when the judgment result in step S182 indicates affirmation, i.e. that the distance difference exceeds the distance threshold value (“Y” in step S182), the operation flow goes to step S184.

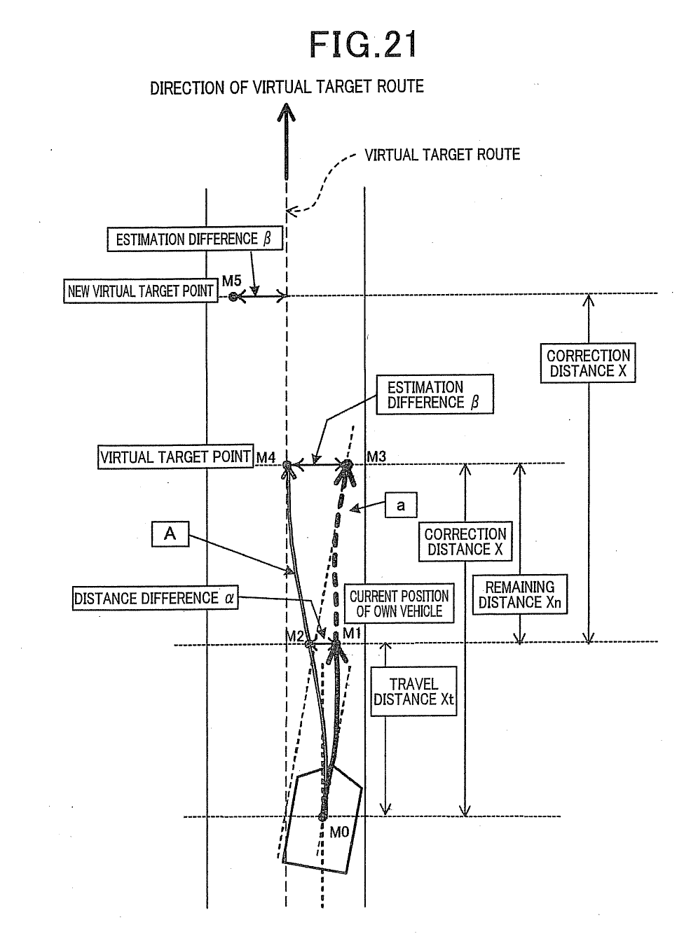

In step S184, the control section 20 determines a new virtual target point on the basis of the distance difference detected in step S182. FIG. 21 is a view showing an explanation for calculating the new virtual target point. A description will now be given of the calculation of the new virtual target point.

As shown in FIG. 21, a travel distance Xt is defined from a route start point M0 to a current position M1 of the own vehicle, where the route start point M0 is a setting start point of the correction route (designated by the solid line A shown in FIG. 21). When the own vehicle runs by the correction steering amount which is determined on the basis of the correction route (designated by the solid line A shown in FIG. 21), an actual travel estimation route (designated by a dotted line a shown in FIG. 21) is defined as an estimation route on which the own vehicle actually runs.

Furthermore, when the own vehicle is running along the actual travel estimation route, where a residual distance Xn is a difference between the correction distance X and the travel distance Xt, the control section 20 estimates an arrival estimation position M3 when the own vehicle is running from the current position M1 by the residual distance Xn. Still further, the control section 20 determines, as an estimation difference β, a difference (as a difference in a lateral position) between a virtual target point M4 in a width direction of the road and the arrival estimation position M3.

The control section 20 calculates the estimation difference β by using a formula (1):

α:Xₜ=β:X,

β=(α·X)/Xₜ (1),

where β is the estimation difference, Xₜ is the travel distance, α is the distance difference, and X is the correction distance.

The control section 20 determines the new virtual target point so that the new virtual target point is separated by the correction distance X from the current position of the own vehicle in the direction of the virtual target route, and is separated by the estimation difference β calculated by the equation (1) in opposite direction from the virtual target route, in the direction which is opposite to the position of the own vehicle through the target route in the both the left side and the right side in the width direction of the road. In addition, the control section 20 determines the new virtual target point M5 as the virtual target point to be used in the process of step S310 which performs the correction steering amount calculation (see FIG. 16). The operation flow goes to step S185.

In step S185, the control section 20 outputs the correction route updating flag (see the sixth exemplary embodiment described). The control section 20 completes the routine indicated by the flow chart shown in FIG. 21.

### [Effects]

As previously described, the control section 20 in the vehicle control device according the eighth exemplary embodiment determines the new virtual target point when the lateral position of the own vehicle is deviated from the correction route by more than the distance threshold value (“Y” in step S183), and outputs the correction route updating flag (step S185). In this case, the control section 20 judges that it is a time to update the correction route (“Y” in step S305) in the next period by the correction control calculation process (step S160), which follows the period in which the control section 20 outputs the correction updating flag in the automatic steering control process. This makes it possible to generate the new correction route by using the new virtual target point.

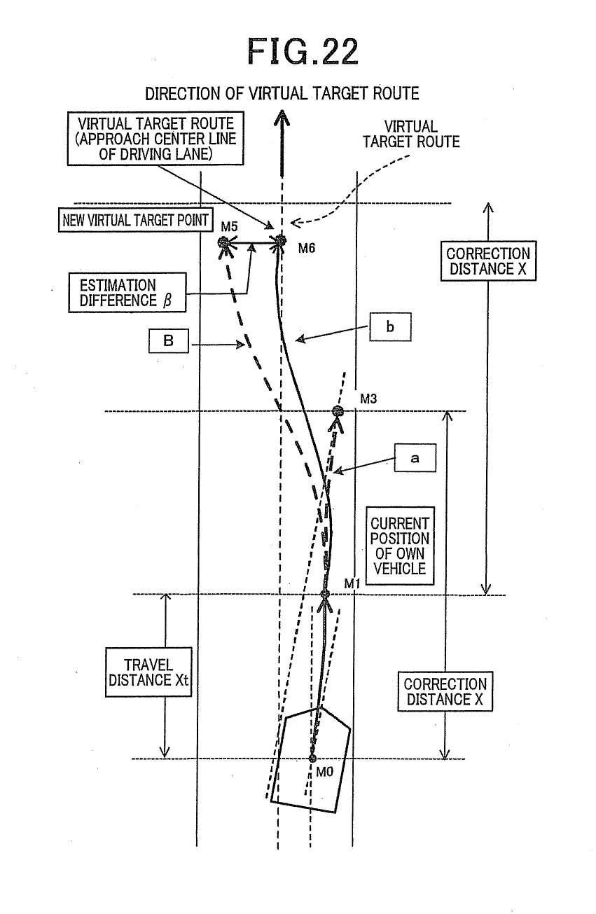

FIG. 22 is a view showing an explanation of a route when the own vehicle runs on the basis of a correction steering amount which is set on the basis of the new correction route to the new virtual target point. That is, as shown in FIG. 22, the control section 20 generates the new correction route (designated by the dotted line B) toward from the current position M1 of the own vehicle to the new virtual target point M5. The own vehicle runs along the route designated by the solid line b shown in FIG. 22 under the steering control on the basis of the correction steering amount which corresponds to the new correction route B. As a result, the own vehicle can approach the virtual target route (the center line of the driving lane).

Accordingly, it is possible for the vehicle control device according to the eighth exemplary embodiment to drive the own vehicle along the target route even if the position of the own vehicle is deviated from the driving estimation route by some reasons such as decreasing of the detection accuracy of the angle of yaw and decreasing of the detection accuracy of a curvature of the driving lane, or by a cross grade of the surface of the driving lane.

### [Correspondence to the Claims]

The automatic steering control process shown in steps S181 to S185 shown in FIG. 20 corresponds to the virtual target point adjustment section used in the claims. The process in step S183 shown in FIG. 20 corresponds to the distance difference judgment section used in the claims. The process in step S185 shown in FIG. 20 corresponds to the correction route updating instruction section used in the claims.

### First Modification

The control section 20 in the exemplary embodiments previously described determines the position of the new virtual target position in the width direction of the road which is apart from the virtual target route by the estimation difference β at the opposite to the position of the own vehicle in both the right side and the left side in the width direction of the road. However, the concept of the present invention is not limited by this. It is possible to determine the position of the new virtual target position in the width direction of the road, which is separated by a predetermined distance from the virtual target route in the opposite to the current position of the own vehicle in both the right side and the left side in the width direction of the road. Thus, it is possible to approach the driving route of the own vehicle to the target route (the basic route) by repeating the process to correct the virtual target point when the current position of the own vehicle is separated from the correction route by the distance difference α.

### Second Modification

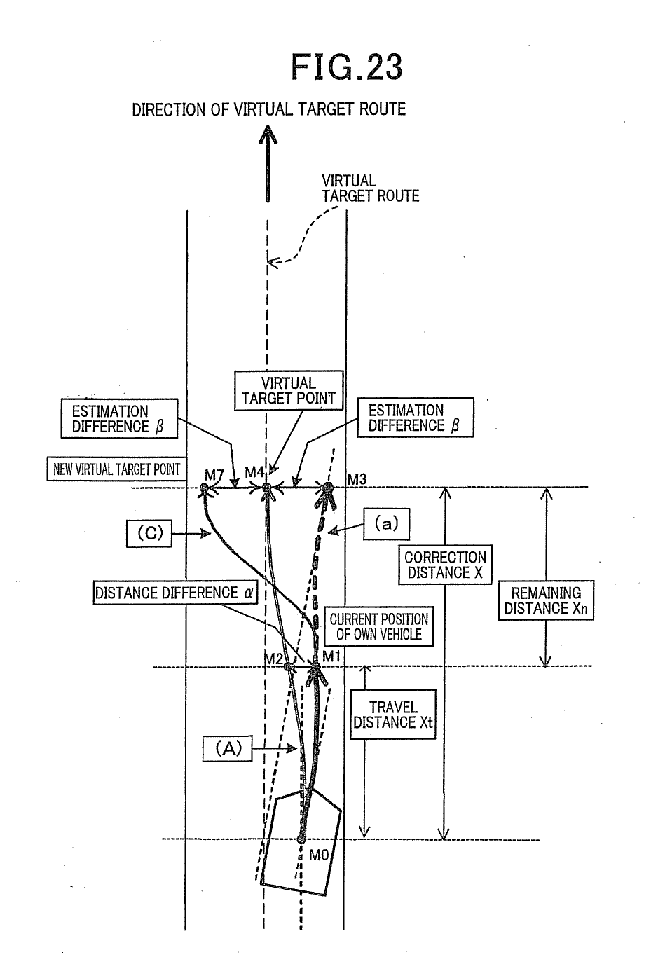

FIG. 23 is a view showing an explanation for calculating the new virtual target point used in a second modification of the vehicle control device according to the eighth exemplary embodiment.

The control section 20 according to the exemplary embodiments previously described determines the position of the new virtual target position in the direction of the new virtual target position which is apart from the current position of the own vehicle by the correction distance. However, the concept of the present invention is not limited by this. For example, when the travel distance Xₜ is relatively a small value, as shown in FIG. 23, it is possible for the control section to determine the position of the new virtual target position M6 in the direction of the virtual target route by the residual distance Xn from the current position M1 of the own vehicle in front of the direction of the virtual target route, similar to the virtual target position M4.

### Other Modifications

The first to eighth exemplary embodiments and the modifications thereof are explained as previously describe. However, the concept of the present invention is not limited by those. It is possible for the vehicle control device to have the various modifications without limiting the scope of the present invention.

In the exemplary embodiments previously described, the control section sets the angle of yaw to zero. It is possible for the control section 20 to determine the angle of yaw or to determine the lateral position only instead of the angle of yaw as the target posture of the own vehicle, or possible to determine both the angle of yaw and the lateral position as the target posture of the own vehicle.

The control section 20 determines the route passing through the center line of the driving lane as the basic route. However, the concept of the present invention is not limited by those. It is possible for the vehicle control device to determine a shape along the driving lane as the basic route.

Still further, in the exemplary embodiments previously described, the control section 20 detects, as the posture of the own vehicle, the offset distance or the angle of yaw on the basis of the image captured by the camera (image sensor) 11. However, the concept of the present invention is not limited by those. For example, it is possible for the control section of the vehicle control device to detect the posture of the own vehicle by a laser radar. It is also possible for the control section 20 to detect the angle of yaw by a yaw rate sensor.

Still further, in the exemplary embodiments, the control section 20 detects the estimation value of the radius of curvature of the basic route on the basis of the image data captured by the camera (image sensor) 11. However, the concept of the present invention is not limited by those. It is also possible for the vehicle control section 20 to obtain an estimation value of the radius of curvature of the basic route on the basis of map information provided from a navigation device when a navigation device is equipped with the own vehicle, and on the basis of signals transmitted from a GPS satellite.

In addition, in the exemplary embodiments, the control device 20 detects the vehicle speed on the basis of the information transmitted from the speed sensor 12 in the detection section 10. However, the concept of the present invention is not limited by those. It is possible for the vehicle control device to detect the vehicle speed of the own vehicle obtained by the camera (image sensor) without incorporate the speed sensor.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A vehicle control device comprising:
a driving lane detection section configured to detect a driving lane on which own vehicle is driving;
a basic steering amount calculation section configured to calculate a basic steering amount which is a steering control amount to drive the own vehicle on a basic route, the basic route is extended along a shape of the driving lane of the own vehicle;
a posture detection section configured to detect a posture of the own vehicle designated by a lateral position and an angle of yaw of the own vehicle, the lateral position of the own vehicle being a position in a width direction of the driving lane, and a route direction being a tangential direction of the basic route at the position of the own vehicle, and the angle of yaw being a slope of the front direction of the own vehicle from the route direction;
an offset distance detection section configured to detect e, as an offset distance, a distance between the basic route and the lateral position of the own vehicle;
a correction steering amount calculation section configured to determine a virtual target point which is apart from a current position of the own vehicle by a predetermined distance in the route direction and is apart from the current position of the own vehicle by the offset distance in a width direction of the driving lane, and configured to determine, as a correction route, a virtual driving route to alien the posture of the own vehicle to a target posture of the own vehicle which is determined in advance, and configured to calculate, as the steering control amount, a correction steering amount in order to drive the own vehicle along the correction route; and
an instruction steering amount calculation section configured to calculate an instruction steering amount of the own vehicle on the basis of the basic steering amount and the correction steering amount.

2. The vehicle control device according to claim 1, the correction route is determined by performing an approximate curve between the current position of the own vehicle and the virtual target point.

3. The vehicle control device according to claim 1, wherein the correction distance is determined to a large value when the more the vehicle speed of the own vehicle is high.

4. The vehicle control device according to claim 1, wherein
the basic steering amount calculation section uses a basic updating period when calculating the basic steering amount, the correction steering amount calculation section uses a correction updating period when calculating the correction steering amount, and wherein the correction updating period is shorter in time than the basic updating period.

5. The vehicle control device according to claim 1, wherein the correction steering amount calculation section comprises a correction updating period setting section for setting the correction updating period, and the correction updating period setting section decreases the correction updating period according to decreasing of the offset distance.

6. The vehicle control device according to claim 4, wherein the correction steering amount calculation section uses a correction route updating period when calculating the correction route, and wherein the correction updating period is shorter in time than the correction route updating period.

7. The vehicle control device according to claim 5, wherein the correction steering amount calculation section uses a correction route updating period when calculating the correction route, and wherein the correction updating period is shorter in time than the correction route updating period.

8. The vehicle control device according to claim 1, wherein the instruction steering amount calculation section calculates the instruction steering amount of the own vehicle to decrease a deviation of the posture of the own vehicle from the correction route.

9. The vehicle control device according to claim 8, wherein the correction steering amount calculation section comprises a correction steering amount adjustment section for adjusting the correction steering amount to decrease a deviation of the posture of the own vehicle from the correction route.

10. The vehicle control device according to claim 8, further comprising a virtual target point adjustment section for adjusting the virtual target point to decrease a deviation of the lateral position of the own vehicle from the correction route.

11. The vehicle control device according to claim 10, wherein the virtual target point adjustment section comprises a correction route updating instruction section for instructing the correction steering amount calculation section to calculate the correction steering amount on the basis of the correction route which is updated by using the virtual target point, where the virtual target point is adjusted to decrease the deviation of the lateral position of the own vehicle from the correction route.

12. The vehicle control device according to claim 11, wherein the virtual target point adjustment section comprises a distance difference judgment section for judging whether or not a distance difference exceeds a predetermined distance threshold value, where the distance difference is a deviation of the lateral position of the own vehicle from the correction route, and
the correction route updating instruction section instructs the correction steering amount calculation section to calculate the correction steering amount on the basis of the correction route when the distance difference judgment section judges that the distance difference exceeds the predetermined distance threshold value.
